(19) United States
(12) Patent Application Publication
(10) Pub. No.: US 2003/0002666 A1
(43) Pub. Date: Jan. 2, 2003

(54) METHOD AND APPARATUS FOR CREATING A MESSAGE DIGEST USING A PARALLEL, ONE-WAY HASH ALGORITHM

(76) Inventor: Richard J. Takahashi, Phoenix, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 09/880,699

(22) Filed: Jun. 13, 2001

(51) Int. Cl. H04L 9/00

(52) U.S. Cl. 380/42

(57) ABSTRACT

A one-way hash algorithm is implemented in hardware and/or software. The hash algorithm creates a message digest from an input message. During one 16-operation round of the hash algorithm, a front computation process (202, FIG. 2) computes a portion of a first operation. Then a systolic computation process (204, FIG. 2) computes the remainder of the first operation and the next fifteen operations to complete the round. The systolic computation process pre-calculates (325, FIG. 3) a portion of the next round in parallel with the completion of the current round. Because the systolic computation process has a shallower logic depth, and because certain calculations are done in parallel, an approximately four times reduction in the time to compute one round can be achieved. In one embodiment, the message digest computed by the hash algorithm is identical to a message digest computed using a conventional MD5 implementation, when given the same input message.

### TECHNICAL FIELD OF THE INVENTION

The present invention relates generally to methods and apparatus for computing condensed representations of messages or data files, and more particularly to methods and apparatus for computing message digests using a one-way hash algorithm.

### BACKGROUND OF THE INVENTION

Hash functions have been widely used in modern cryptography to produce compressed data, message digests, fingerprints, and checksums, among other things. A hash function is a mathematical function that takes a variable-length input string, and converts it to a fixed-length output string. The output string is called a hash value, which typically is smaller than the input string. A “one-way” hash function is a hash function that works in one direction, meaning that it is easy to compute a hash value from an input string, but it is difficult to generate a second input string that hashes to the same value. Bruce Schneier, Applied Cryptography, at 429-59 (1996) includes a detailed discussion of various one-way hash algorithms.

A commonly used, one-way hash algorithm is “MD5”, where MD stands for “message digest.” MD5 was developed by Ron L. Rivest, and is described in detail in his paper entitled “The MD5 Message Digest Algorithm,” RFC 1321 (April 1992).

When an arbitrarily large input message is input into MD5, the algorithm produces a 128-bit output called a “fingerprint” or “message digest” of the input message. MD5 sequentially processes message blocks of 512 bits when computing a message digest. If a message is not a multiple of 512 bits, then MD5 first pads the message to make the message a multiple of 512 bits. The padded message is then processed by MD5 as n 512-bit blocks, Mₗ, . . . , Mₙ, where each block is composed of sixteen 32-bit words or sub-blocks, Wⱼ, 0<=j<=15. The main loop of MD5 processes each 512-bit block one at a time, and continues for as many 512-bit blocks as are in the message. The output of the algorithm is a set of four 32-bit words, which concatenate to form a single 128-bit message digest. A four-word buffer (A, B, C, D) is used to compute the message digest, where each of A, B, C, and D is a 32-bit register, and the registers are initialized to particular values.

The main loop of MD5 has four “rounds,” r (0<=r<=3), where each round includes sixteen operations. Accordingly, sixty-four operations, i (0<=i<=63), are performed for each message block.

During each operation, a non-linear function (NLF) is performed on three of four 32-bit variables stored in A, B, C, and D. Then the operation adds the NLF output to the fourth variable, a sub-block, Wⱼ, of the message, and a constant word, kᵢ. The operation then performs a left circular shift of a variable number of bits, sᵢ, and adds the result to the contents of one of A, B, C or D. Finally, that sum replaces the contents of one of A, B, C or D, and the next operation is performed. The NLF used for the operations in each round (i.e., each set of 16 sequential operations) is different from the NLF used in the previous round.

After the fourth round, the main loop repeats for the next message block, until the last block, Mₙ, has been processed. After processing the last block, the message digest is the 128-bit string represented by the concatenated words stored in A, B, C, and D.

MD5 can be performed by software or within an application specific integrated circuit (ASIC), where the operations are performed using hardware-implemented logic gates. FIG. 1 illustrates a simplified, logical block diagram of one MD5 operation, in accordance with the prior art. Registers A, B, C, and D are represented by blocks 102, 104, 106, 108.

During one operation, a non-linear function 112 (NLFᵣ) is applied to three of the variables stored in registers A, B, C, and D. In the example round shown, the three variables input into NLF 112 are the variables stored in B 104, C 106, and D 108, although the input variables could differ for other rounds. The result is added, by a first full adder 114, to the contents of register A 102. A second full adder 116 adds the output of the first full adder 114 to the appropriate sub-block, Wⱼ, for the round and operation being performed. A third full adder 118 then adds the output of the second full adder 116 to the appropriate constant word, kᵢ, for the round and operation being performed.

A shifter 120 then circularly left shifts the output of the third full adder 118 by the appropriate number of bits, sᵢ, for the round and operation being performed. Finally, the contents of register B 104 is added, by a fourth full adder 122, to the output of shifter 120. The output of full adder 122 is then added to the contents of register B 104, and that sum is placed in register A 102, for use during the next operation. The next operation will then use a different message sub-block, Wⱼ, constant word, kᵢ, and number of shifts, sᵢ, in the left circular shift operation. In addition, the next operation will input the contents of different registers into NLF 112 and adders 114, 122. Finally, the result will be placed in a different register.

During the four rounds associated with one message block, the logic blocks illustrated in FIG. 1 are cycled through sixty-four times. Further, the total number of cycles through the logic of FIG. 1 is 64×n, where n is the number of 512-bit blocks in the message. Each cycle through the logic corresponds to one clock cycle, and the clock frequency is limited by the various delays associated with the gates and other logical components. The logic depth of the operation illustrated in FIG. 1 is rather substantial, because the logic includes computationally complex full adders, among other elements. Accordingly, the cumulative delay associated with this design is long, and consequently the clock frequency must be fairly low.

As the desire to compress data faster increases, communication systems increasingly place more stringent demands on the computation speed of cryptographic algorithms. Accordingly, what are needed are one-way hash algorithms and apparatus, which produce the same output as MD5 in less time. Further, what are needed are an MD5 compatible hash algorithm and apparatus, which have less logic depth than the standard MD5 implementation.

### BRIEF DESCRIPTION OF THE DRAWING

FIG. 1 illustrates a simplified, logical block diagram of one MD5 operation, in accordance with the prior art;

FIG. 2 illustrates a simplified, logical block diagram corresponding to one round of sixteen operations, in accordance with one embodiment of the present invention;

FIG. 3 illustrates a flowchart of a method for creating a message digest, in accordance with one embodiment of the present invention; and

FIG. 4 illustrates an electronic device in which the embodiments of the invention may be practiced, in accordance with one embodiment of the present invention.

### DETAILED DESCRIPTION OF THE INVENTION

Various embodiments of the present invention provide a one-way has algorithm and apparatus, which produce the identical message digest as MD5, given the same input message, but in nearly half the time necessary using the standard MD5 implementation. In various embodiments, this is accomplished by separately computing part of the first operation of a 16-operation round using a front computation process, and computing the remaining operations of the round using a very fast systolic computation process. Because it has fewer delays in its logic, the systolic computation process can be performed using a clock rate that is approximately twice the clock rate possible using the standard MD5 implementation. In addition, the systolic computation process computes portions of adjacent operations in parallel. Accordingly, the time to compute each 16-operation round is reduced, using the various embodiments, to nearly half the time necessary to compute each 16-operation round using the standard MD5 implementation.

Similar to MD5, when an input message of any arbitrary length of bits is input into the algorithm of one of the various embodiments, the algorithm produces a 128-bit output, referred to herein as a message digest. Although the term “message digest” has been used to indicate the output result of the algorithm, such terminology is not meant to limit the various embodiments to specific applications.

In one embodiment, the method of the present invention sequentially processes blocks of 512 bits when computing a message digest. If a message is not a multiple of 512 bits, then the algorithm first pads the message to make the message a multiple of 512 bits.

The padded message is then processed by MD5 as n 512-bit blocks, Mₗ, . . . , Mₙ, where each block is composed of sixteen 32-bit words or sub-blocks, Wⱼ (0<=j <=15). The main loop of MD5 processes each 512-bit block one at a time, and continues for as many 512-bit blocks as are in the message. The output of the algorithm is a set of four 32-bit words, which concatenate to form a single 128-bit message digest.

A four-word buffer (A, B, C, D) is used to compute the message digest, where each of A, B, C, and D is a 32-bit register. These registers are initialized to particular values, which are the same initialization values as are used in the standard MD5 implementation.

As described previously, the main loop of MD5 has four rounds, r (0<=r<=3), where each round includes sixteen operations. Accordingly, sixty-four operations, i (0<=i<=63), are performed for each message block. An “operation” is defined herein as a set of processes that operates on a word of the sequence of input words derived from the message. In one embodiment, the set of processes associated with each operation are described in the next paragraph. For one word, the set of processes culminates in the replacement of one of the registers A, B, C or D with a result that is calculated during the set of processes for that word.

During each operation, the set of processes includes the following, in one embodiment. First, a non-linear function (NLF) is performed on three of four 32-bit variables stored in A, B, C, and D. Then the operation adds the NLF output to the fourth variable, a sub-block, Wⱼ, of the message (i.e., a word of the message), and a constant word, kᵢ. The operation then performs a left circular shift of a variable number of bits, sᵢ, and adds the result to the contents of one of A, B, C or D. Finally, that sum replaces the contents of one of A, B, C or D.

In one embodiment, part of the first operation of a 16-operation round is separately computed using a front computation process, and the remaining operations of the round are computed using a very fast systolic computation process. This systolic computation process, which is described in detail below, performs portions of consecutive operations in parallel. This parallel processing, along with a more shallow logic depth per operation, enable the time to compute each round to be substantially reduced, because a faster clock frequency can be used for the systolic computation process.

The NLF used for the operations in each round (i.e., each set of 16 sequential operations) is different from the NLF used in the previous round. Each NLF takes as input three 32-bit words and produce as output one 32-bit word. The four NLFs are defined as follows, and are the same as the NLFs used in the standard MD5 implementation:

F(X,Y,Z)=(X AND Y) OR ((NOT X) AND Z) (for round 1:0<=i<=15)

G(X,Y,Z)=(X AND Z) OR (Y AND (NOT Z)) (for round 2:16<=i<=31)

H(X,Y,Z)=X XOR Y XOR Z (for round 3:32<=i<=47)

I(X,Y,Z)=Y XOR (X OR (NOT Z)) (for round 4:48<=i<=63).

The main loop of the algorithm is performed as described below. First, the values in the four registers of the buffer (A, B, C, D) are retained and copied into four 32-bit variables a, b, c, and d, so that a=A, b=B, c=C, and d=D.

Each of the four rounds is then performed by applying the following logic, which is the same logic as is used in the standard MD5 implementation. In the functions below, Wⱼ represents the jth sub-block of the message (0<=j<=15), <<<sᵢ represents a left circular shift of s bits, and “+” denotes the addition of words. The actual values for Wⱼ, kᵢ, and sᵢ for each operation, i, are found in the “List of Operations” table, below.

Round 1: For i=0 to 15,

FF(a,b,c,d, Wⱼ, sᵢ, kᵢ) denotes the operation

a=b+((a+F(b,c,d)+Wⱼ+kᵢ)<<<sᵢ).

Round 2: For i=16 to 31,

GG(a,b,c,d, Wⱼ, sᵢ, kᵢ) denotes the operation

a=b+((a+G(b,c,d)+Wⱼ+kᵢ)<<<sᵢ).

Round 3: For i=32 to 47,

HH(a,b,c,d, Wⱼ, sᵢ, kᵢ) denotes the operation

a=b+((a+H(b,c,d)+Wⱼ+kᵢ)<<<sᵢ).

Round 4: For i=48 to 63,

II(a,b,c,d, Wⱼ, sᵢ, kᵢ) denotes the operation

a=b+((a+I(b,c,d)+Wⱼ+kᵢ)<<<sᵢ).

During each round, r (0<=r<=3), the three variables operated upon by the NLF, the message sub-block, Wⱼ, the constant word, kᵢ, and the number of shifts, sᵢ, in the left circular shift operation change from operation to operation. For each round and operation, these operations are performed sequentially as follows, where the operations listed below are identical to the 64 operations used in the standard MD5 implementation. The operation number, i (0<=i<=63), are listed to the left of each operation.

List of Operations
Round 1 (r = 0):

| | |
|---|---|
| 0. | FF(a,b,c,d, W₀, 7, d76aa478) |
| 1. | FF(d,a,b,c, W₁, 12, e8c7b756) |
| 2. | FF(c,d,a,b, W₂, 17, 242070db) |
| 3. | FF(b,c,d,a, W₃, 22, c1bdceee) |
| 4. | FF(a,b,c,d, W₄, 7, f57c0faf) |
| 5. | FF(d,a,b,c, W₅, 12, 4787c62a) |
| 6. | FF(c,d,a,b, W₆, 17, a8304613) |
| 7. | FF(b,c,d,a, W₇, 22, fd469501) |
| 8. | FF(a,b,c,d, W₈, 7, 698098d8) |
| 9. | FF(d,a,b,c, W₉, 12, 8b44f7af) |
| 10. | FF(c,d,a,b, W₁₀, 17, ffff5bb1) |
| 11. | FF(b,c,d,a, W₁₁, 22, 895cd7be) |
| 12. | FF(a,b,c,d, W₁₂, 7, 6b901122) |
| 13. | FF(d,a,b,c, W₁₃, 12, fd987193) |
| 14. | FF(c,d,a,b, W₁₄, 17, a679438e) |
| 15. | FF(b,c,d,a, W₁₅, 22, 49b40821) |

Round 2 (r = 1):

| | |
|---|---|
| 16. | GG(a,b,c,d, W₁, 5, f61e2562) |
| 17. | GG(d,a,b,c, W₆, 9, c040b340) |
| 18. | GG(c,d,a,b, W₁₁, 14, 265e5a51) |
| 19. | GG(b,c,d,a, W₀, 20, e9b6c7aa) |
| 20. | GG(a,b,c,d, W₅, 5, d62f105d) |
| 21. | GG(d,a,b,c, W₁₀, 9, 02441453) |
| 22. | GG(c,d,a,b, W₁₅, 14, d8a1e681) |
| 23. | GG(b,c,d,a, W₄, 20, e7d3fbc8) |
| 24. | GG(a,b,c,d, W₉, 5, 21e1cde6) |
| 25. | GG(d,a,b,c, W₁₄, 9, c33707d6) |
| 26. | GG(c,d,a,b, W₃, 14, f4d50d87) |
| 27. | GG(b,c,d,a, W₈, 20, 455a14ed) |
| 28. | GG(a,b,c,d, W₁₃, 5, a9e3e905) |
| 29. | GG(d,a,b,c, W₂, 9, fcefa3f8) |
| 30. | GG(c,d,a,b, W₇, 14, 676f02d9) |
| 31. | GG(b,c,d,a, W₁₂, 20, 8d2a4c8a) |

Round 3 (r = 2):

| | |
|---|---|
| 32. | HH(a,b,c,d, W₅, 4, fffa3942) |
| 33. | HH(d,a,b,c, W₈, 11, 8771f681) |
| 34. | HH(c,d,a,b, W₁₁, 16, 6d9d6122) |
| 35. | HH(b,c,d,a, W₁₄, 23, fde5380c) |
| 36. | HH(a,b,c,d, W₁, 4, a4beea44) |
| 37. | HH(d,a,b,c, W₄, 11, 4bdecfa9) |
| 38. | HH(c,d,a,b, W₇, 16, f6bb4b60) |
| 39. | HH(b,c,d,a, W₁₀, 23, bebfbc70) |
| 40. | HH(a,b,c,d, W₁₃, 4, 289b7ec6) |
| 41. | HH(d,a,b,c, W₀, 11, eaa127fa) |
| 42. | HH(c,d,a,b, W₃, 16, d4ef3085) |
| 43. | HH(b,c,d,a, W₆, 23, 04881d05) |
| 44. | HH(a,b,c,d, W₉, 4, d9d4d039) |
| 45. | HH(d,a,b,c, W₁₂, 11, e6db99e5) |
| 46. | HH(c,d,a,b, W₁₅, 16, 1fa27cf8) |
| 47. | HH(b,c,d,a, W₂, 23, c4ac5665) |

Round 4 (r = 3):

| | |
|---|---|
| 48. | II(a,b,c,d, W₀, 6, f4292244) |
| 49. | II(d,a,b,c, W₇, 10, 432aff97) |
| 50. | II(c,d,a,b W₁₄, 15, ab9423a7) |
| 51. | II(b,c,d,a, W₅, 21, fc93a039) |
| 52. | II(a,b,c,d, W₁₂, 6, 655b59c3) |
| 53. | II(d,a,b,c, W₃, 10, 8f0ccc92) |
| 54. | II(c,d,a,b W₁₀, 15, ffeff47d) |
| 55. | II(b,c,d,a, W₁, 21, 85845dd1) |
| 56. | II(a,b,c,d, W₈, 6, 6fa87e4f) |
| 57. | II(d,a,b,c, W₁₅, 10, fe2ce6e0) |
| 58. | II(c,d,a,b W₆, 15, a3014314) |
| 59. | II(b,c,d,a, W₁₃, 21, 4e0811a1) |
| 60. | II(a,b,c,d, W₄, 6, f7537e82) |
| 61. | II(d,a,b,c, W₁₁, 10, bd3af235) |
| 62. | II(c,d,a,b W₂, 15, 2ad7d2bb) |
| 63. | II(b,c,d,a, W₉, 21, eb86d391) |

After round 4 has been completed, a, b, c, and d are added to the retained contents of A, B, C, and D (i.e., the contents before this message block was processed), respectively. The main loop then repeats for the next message block, until the last block, Mₙ, has been processed. After processing the last block, the message digest is the 128-bit string represented by the concatenated words stored in A, B, C, and D.

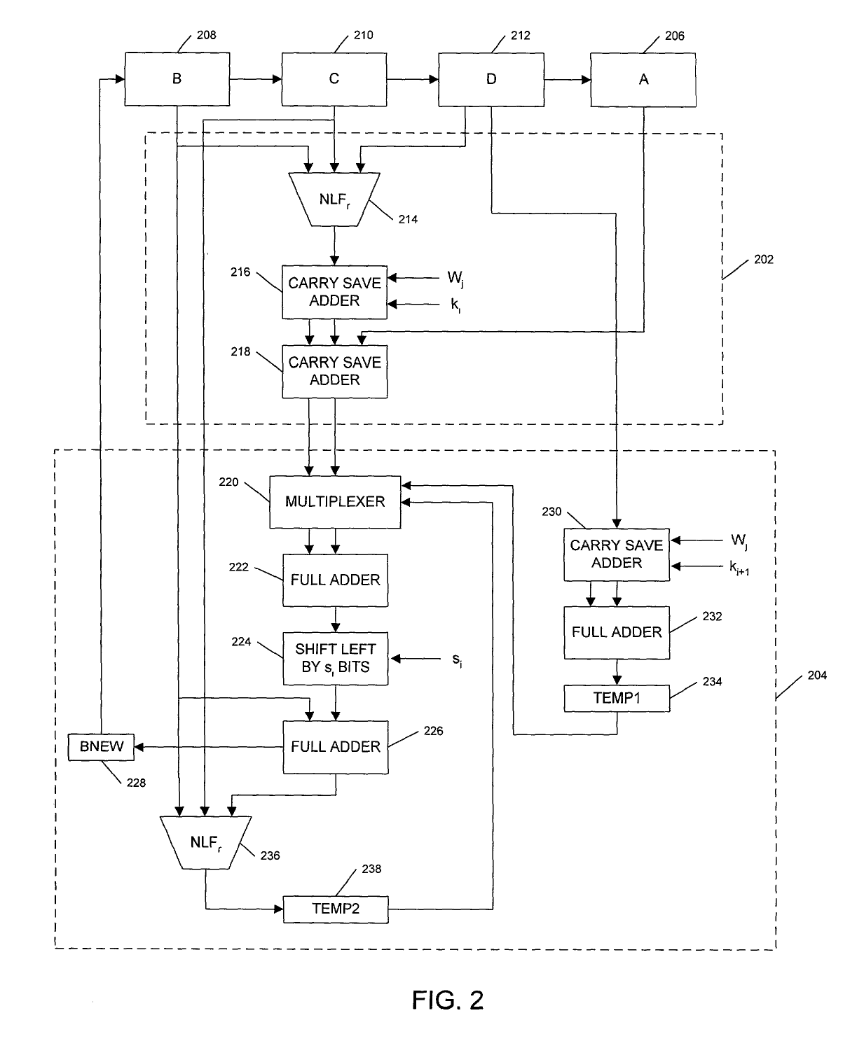

FIG. 2 illustrates a simplified, logical block diagram corresponding to one round of sixteen operations, in accordance with one embodiment of the present invention. The logic for performing one round includes two major logic blocks: a front computation block 202 and a systolic computation block 204. The variable t (0<=t<=15) indicates which operation is being performed within a round, r (0<=r<=3). Accordingly, the operation number, i, is equal to t×r.

The front computation block 202 performs a portion of the first operation (i.e., t=0) for each round. The systolic computation block 204 performs a remainder of the first operation, and each of the fifteen subsequent operations (i.e., 1<=t<=15) that comprise the round. In one embodiment, the front computation block 202 is clocked at a first clock frequency (e.g., 200 MHz), and the systolic computation block 204 is clocked at a second, faster clock frequency (e.g., 400 MHz).

The first clock frequency can be approximately equal to the clock frequency used in a standard MD5 implementation. This first clock frequency is limited, on the high end, by the delays associated with the logic within the front computation block 202. The second clock frequency can be approximately equal to twice the clock frequency used in a standard MD5 implementation, because the delays associated with the systolic computation block 204 are substantially less than the delays associated with performing one standard MD5 operation. Accordingly, the various embodiments of the present invention are able to compute one 16-operation round in nearly half the time it takes to compute a round using a standard MD5 implementation. Where a standard MD5 implementation uses 64 clock cycles at a particular clock frequency, the various embodiments of the present invention use the equivalent of approximately 34 clock cycles at the particular clock frequency.

In one embodiment, it takes one clock cycle to complete the front computation portion 202, and one clock cycle (potentially at a higher frequency) to complete each iteration through the systolic computation portion 204. In other embodiments, it could take more that one clock cycle to complete either or both the front computation and/or systolic computation portions. In other words, during a particular round, the front computation portion 202 is performed during one or more clock cycles, and each iteration of the systolic computation portion 204 is performed during one or more subsequent clock cycles.

Referring again to FIG. 2, registers A, B, C, and D are represented by blocks 206, 208, 210, 212. When a round begins, the front computation portion 202 is performed first.

During the front computation portion 202, a first non-linear function block 214 (NLFᵣ) is applied to the contents of registers B 208, C 210, and D 212. During the first round (r=0), the appropriate NLF to use is F(X,Y,Z)=(X AND Y) OR ((NOT X) AND Z), where X=B, Y=C, and Z=D. A first carry save adder 216 (CSA) adds the output of NLF 214 to Wⱼ and kᵢ. For example, during the first operation of the first round, Wⱼ=W₀ and kᵢ=d76aa478 (See the “List of Operations” table, above). First CSA 216 is a three-input/two-output carry save adder, in one embodiment. In other embodiments, multiple CSAs and/or full adders could be used to add the three inputs.

A second CSA 218 then adds the output of the first CSA 216 to the contents of register A 206. In one embodiment, second CSA 218 also is a three-input/two-output carry save adder, although multiple CSAs and/or full adders could be used to add the three inputs, in other embodiments.

During the front computation portion 202, a variable, v, is set to a value of 1. The variable roughly indicates which operation, within a particular round, is being performed. Although the first operation has not yet been completed, setting v to the value of 1 enables the logic in the systolic computation portion 204 to perform correctly.

The systolic computation portion 204 is then performed. First, a multiplexer 220, is used to select, as input, either the output of the front computation portion 202, or values generated within the systolic computation portion 204. When v=1, multiplexer 220 selects the output of the front computation portion 202, which includes a sum and a carry produced by CSA 218. Multiplexer 220 then passes the sum and carry to a first fall adder 222. When v>1, multiplexer 220 selects a stored output of a second fall adder 232 and a stored result produced by a second NLF block 236, and passes those values to the first full adder 222.

The first full adder 222 adds the two values received from multiplexer 220. Shifter 224 then circularly left shifts the output of first full adder 222 by a variable number of bits, sᵢ, which has a value that depends on the number of the operation, i, being performed. For example, during the first operation, i=0, of the first round, r=0, sᵢ=7 bits. During the second operation, i=1, of the first round, sᵢ=12 bits, and so on (See the “List of Operations” table, above). In one embodiment, shifter 224 is implemented as a hard-wired shift. In another embodiment, shifter 224 is implemented through logic, or is performed using software. Although a left circular shift is used in one embodiment, the same result could also be achieved using a right circular shift of a complementary number of bits.

A third full adder 226 then adds the output of shifter 224 to the contents of register B 208. The output of third full adder 226 represents the final result of an operation. Accordingly, for example, if the operation is the first operation of a first round, the output represents FF(a,b,c,d,W₀,7,d76aa478). If the operation is the second operation of the first round, the output represents FF(d,a,b,c,W₁,12,e8c7b756) (See the “List of Operations” table, above).

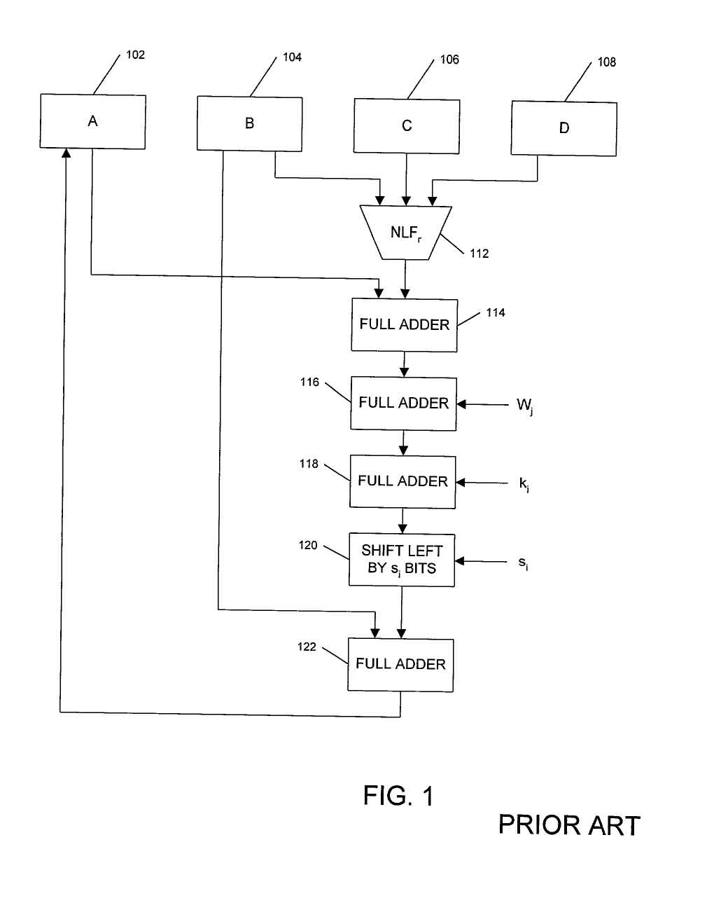

The output of third full adder 226 corresponds to the result produced by full adder 122 (FIG. 1) used in a standard MD5 implementation. As FIG. 1 indicates, in the standard MD5 implementation, that result is added to the contents of register A 102 (FIG. 1). However, in one embodiment of the present invention, the result is temporarily stored as variable BNEW 228. The later incorporation of BNEW 228 into the four-word register A, B, C, and D will be explained below.

In one embodiment, a portion of the next operation is computed in parallel with blocks 220-226, which represent a portion of the preceding operation. Specifically, a third CSA 230 is used to add the contents of register D 212 to Wⱼ and kᵢ₊₁. For example, during the second operation of the first round, Wⱼ=W₁ and kᵢ₊₁=e8c7b756 (See the “List of Operations” table, above). Third CSA 230 is a three-input/two-output carry save adder, in one embodiment. In other embodiments, multiple CSAs and/or fill adders could be used to add the three inputs. A second full adder 232 adds the outputs of the third CSA 230 (i.e., it incorporates the carry into the sum). The output of the second full adder 232 is temporarily held in register TEMP1 234, until the systolic computation block 204 is clocked for the next cycle.

Another portion of the next operation is performed when a second NLF block 236 is applied to the output of the third full adder 226 (i.e., BNEW), and the contents of register B 208 and register C 210. The appropriate NLF to use is the same as the NLF used for the first NLF block 214. Accordingly, during the first round, the appropriate NLF to use is F(X,Y,Z)=(X AND Y) OR ((NOT X) AND Z), where X=BNEW, Y=B, and Z=C. The output of NLF 236 is temporarily held in register TEMP2 238, until the systolic computation block 204 is clocked for the next cycle.

Concurrently with clocking the systolic computation block 204 for the next cycle, the contents of registers B 208, C 210, D 212, and A 206 are replaced, so that A=D, D=C, C=B, and B=BNEW 128. These new register values are then available for the next cycle.

The variable v is then incremented by 1. If v is less than 16, but greater than 1, then multiplexer 220 selects, as input, the values within TEMP1 234 and TEMP2 238, and the systolic computation block 204 completes the next operation, as described above. The procedure then iterates until all of the round's operations have been performed. If v=16, then the front computation portion 202 is again performed for the next round, as described above, and the procedure iterates until all four rounds have been performed. After adding the results from the four rounds to retained contents of A, B, C, and D, the entire procedure then iterates for each remaining message block. Once all message blocks have been processed, the message digest is the concatenation of the contents of registers A, B, C, and D. In one application, the message digest can then be input into a verification or signature algorithm (e.g., DSA), or can otherwise be stored, transmitted, or used to compute a value that has some usefulness.

The above description indicates that a portion of one operation is performed in parallel with a portion of a next operation (i.e., some of the processes involved in each operation are performed in parallel). The remaining processes of the next operation are performed later. When the embodiment is implemented using logic, the portion of one operation and the portion of the next operation are completed during a first clock cycle, and the remaining processes of the next operation are completed during the next clock cycle. When one of the operations is the first operation of a round, the initial portion of the operation is performed during a preceding clock cycle (i.e., it is performed before performing the remaining processes of the first operation).

Using the embodiment shown in FIG. 2, the critical path through the majority of operations (1<=t<=15) includes multiplexer 220, shifter 224, two full adders 222 and 226, NLF 236, and register setup time. Referring to FIG. 1, using a conventional MD5 implementation, the critical path for each operation includes NLF 112, four full adders 114, 116, 118, 122, shifter 120, and register setup time. Because the critical path for the embodiment shown in FIG. 2 includes only two full adders for most operations, as opposed to four full adders in the critical path for a conventional MD5 implementation, the logic depth and the amount of time to process a full message is substantially reduced from the conventional MD5 implementation. With nearly half the logic depth, and the ability to roughly double the clock frequency during the systolic portion 204 of each round, the embodiments of the present invention can compute a message digest in approximately one quarter the time necessary for a conventional MD5 implementation to compute a message digest.

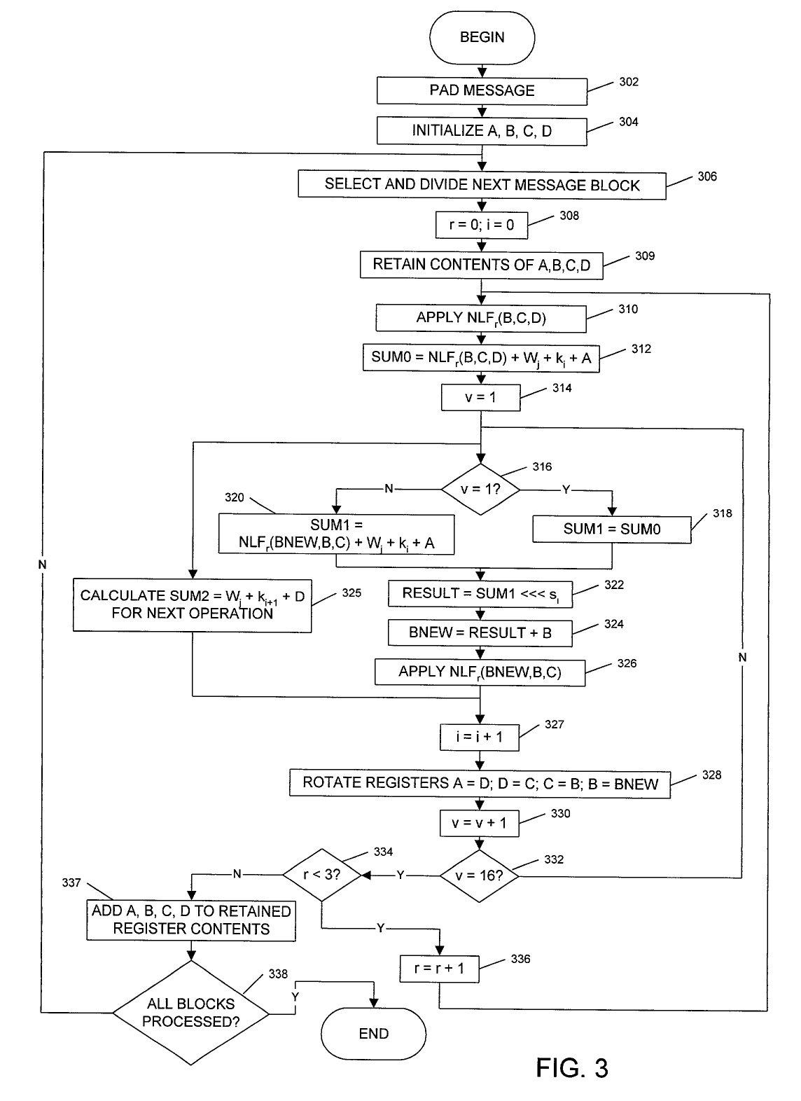

FIG. 3 illustrates a flowchart of a method for creating a message digest, in accordance with one embodiment of the present invention. It would be obvious to one of skill in the art, that the method could be entirely or partially accomplished in an integrated circuit (e.g., an ASIC) and/or by software.

The method begins, in block 302, by padding the message for which a message digest is to be computed, if necessary. As described previously, if a message is not a multiple of 512 bits, then the method first pads the message with a single “1” and as many zeros are necessary to make the message a multiple of 512 bits, except that the last 64 bits of the last 512-bit block are reserved for the length, l, of the original message. The padded message is then processed by the algorithm as n 512-bit blocks, Mₗ, . . . , Mₙ.

In block 304, registers A, B, C, and D are initialized. In one embodiment, these registers are initialized to be the same values as the predetermined set of initialization values used in MD5. These values are as follows, in hexadecimal:

A=01234567

B=89abcdef

C=fedcba98

D=76543210

The outside loop of the algorithm (blocks 306-338), which sequentially selects each message block, Mₗ, . . . , Mₙ, then begins. In block 306, the next message block, Mₓ, is selected for processing, and divided into sixteen 32-bit words, W₀, W₁, . . . , W₁₅ where W₀ is the left-most word. During the first iteration of the outside loop that includes blocks 306-338, the “next block” is block Mₗ. In block 308, a variable r, which indicates which round the algorithm is computing, is then set to a value of 0, and an operation variable i, which indicates which operation is being performed of the 64 operations per message block, is also set to a value of 0. In block 309, the contents of registers A, B, C, and D are retained for later use.

The middle loop of the algorithm (blocks 310-336), which steps through the four rounds for one message block, then begins. Referring also to FIG. 2, the front computation process is initiated, which begins the calculations for the first operation within a round. First, in block 310, a first NLF (e.g., NLFᵣ 214) is applied to the contents of registers B 208, C 210, and D 212. Next, in block 312, the sum of the NLF output, Wⱼ, kᵢ, and the contents of register A 206 is computed. For ease of description, this sum is referred to as “SUM0.” In one embodiment, SUM0 is computed using one or more carry save adders (e.g., adders 216, 218, FIG. 2). The front computation process is completed, in one embodiment, by setting the variable v to a value of 1, in block 314, where the variable v roughly indicates which operation, within a particular round, is being performed.

The inner loop of the algorithm (blocks 316-332), which represents the systolic computation process (e.g., block 204, FIG. 2) of a particular round, then begins. First, the variable v is evaluated, in block 316, to determine if it is equal to 1. In one embodiment, this evaluation is performed by multiplexer 220 (FIG. 2). If v is equal to 1, then the multiplexer selects the outputs of the front computation process (e.g., the outputs of adder 218, FIG. 2) as the inputs to the inner loop calculations. If v is not equal to 1, then the multiplexer selects the outputs of other inner loop components (e.g., registers TEMP1 234 and TEMP2 238, FIG. 2) as the inputs to the inner loop calculations.

The sum of the multiplexer outputs is calculated in either block 318 or 320. For ease of description, this sum is referred to as “SUM1.” If v equals 1, then SUM1=SUM0 is calculated, in block 318. Thus, in one embodiment, SUM1 represents the sum calculated by the front computation process after the carry has been incorporated. If v is not equal to 1, then SUM1=NLFᵣ (BNEW)+SUM2 is calculated, in block 320. As will be described below, SUM2=Wⱼ+kᵢ₊₁+D was pre-calculated during a previous round (see block 325). In one embodiment, SUM1 represents the sum of TEMP1 234 and TEMP2 238 (FIG. 2), and SUM1 is calculated by a full adder (e.g., adder 222, FIG. 2). In block 322, SUM1 is then circularly left shifted by the appropriate number of bits, sᵢ, for the operation. For ease of description the shifted version of SUM1 is referred to as “RESULT.” In one embodiment, the circular shift is performed by a shifter (e.g., shifter 224, FIG. 2).

RESULT is then added, in block 324, to the contents of register B (208, FIG. 2). In one embodiment, this sum is calculated by a full adder (e.g., adder 226, FIG. 2), and is temporarily stored in a register (e.g., register 228, FIG. 2) as variable BNEW. BNEW is the result of the end of an operation, and will later be stored in register 208 (FIG. 2), after the registers have been rotated.

A portion of a next operation is calculated in parallel with any or all of blocks 316-326, by calculating “SUM2,” which equals the sum of Wⱼ, kᵢ₊₁, and the contents of register D 212 (FIG. 2), in block 325. In one embodiment, this calculation is performed by adders 230, 232 (FIG. 2). By pre-calculating this value for the next operation in parallel with the current operation, the critical path for each operation performed in the systolic computation portion is reduced. Accordingly, the time to calculate each round is reduced. Another portion of the next operation is then calculated, in block 326, when a second NLF (e.g., NLFᵣ 236, FIG. 2) is applied to BNEW, and the contents of registers B 208 and C 210 (FIG. 2).

In one embodiment, the operation variable, i, is then incremented by 1, in block 327. In other embodiments, i could be incremented at an earlier or later time. The registers A, B, C, and D are then rotated or replaced, in block 328, so that A=D, D=C, and C=B, and B=BNEW (i.e., the result from the previous operation). The variable v is then incremented by 1, in block 330, and a determination is made, in block 332, whether the variable v=16. If not, it indicates that the round has not yet completed, and the procedure repeats the inner loop, as shown. Specifically, the multiplexer will be called upon to pass the values through that are necessary to perform the next operation. If the variable v=16, it indicates that the round is completed.

If the round is completed, then, in block 337, the contents of registers A, B, C, and D are added to the values previously retained in block 309. A determination is then made, in block 334, whether the variable r is less than 3. If so, it indicates that one or more rounds must still be completed for the message block. In that case, the variable r is incremented by 1 in block 336, and the procedure repeats the middle loop, as shown. Specifically, the front computation process will again be performed for the next round's first operation, and then the systolic computation process will be performed for the remaining fifteen operations.

If the fourth round is completed, a determination is made, in block 338, whether all message blocks, Mₗ, . . . , Mₙ, that comprise the message have been processed. If not, then the process repeats the outer loop, as shown. Specifically, the next message block is selected and divided, and the four rounds (i.e., 64 operations) are performed for the next message block. If all message blocks have been processed, then the method ends.

The above description indicates that the algorithm operates on input words, specifically 32-bit words. In other embodiments, the algorithm could be adapted to operate on larger or smaller words. In addition, in one embodiment, the algorithm and/or the system within which the algorithm operates could be adapted to receive message bits in a serial manner, rather than a parallel manner. In such an embodiment, a sequence of serial bits could be fed into one or more registers (e.g., registers A, B, C, and D, or other registers), and once the register is filled to the register size, the word could be processed as described above. The next set of serial bits would then be loaded into the register, and the process would repeat. Accordingly, in one embodiment, the algorithm could include performing a serial to parallel conversion process, prior to performing a round that operates on the set of serial bits that comprise a word.

In one embodiment, some or all of the algorithm operations are performed within an ASIC, where the operations are performed using logic. In other embodiments, some or all of the algorithm operations are performed using software.

The various embodiments could be used in many different types of devices. For example, they could be used in wired or wireless communication devices (e.g., radios, pagers, cellular or conventional telephones), “smart cards,” PCICM cards, access tokens, routers, switches, and any other device that utilizes a one-way hash algorithm. These examples are provided for purposes of illustration and are not intended to limit the use of the various embodiments in other applications.

The message to be processed could originate at a particular device. For example, the message could be stored within a device or could be generated in real time by the device (e.g., voice data from the device's user). Alternatively, the message could be received from a remote device. In addition, the message digest calculated using the various embodiments could be stored, used or consumed internally by a device, or it could be transmitted to another device for storage and/or processing.

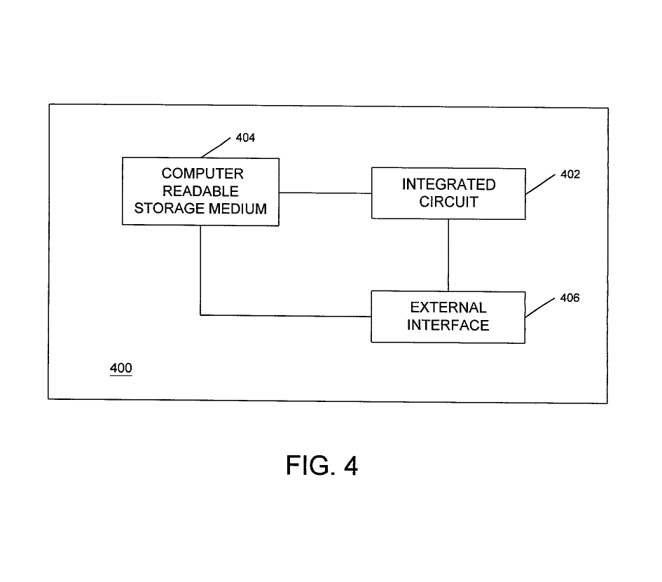

FIG. 4 illustrates an electronic device in which the embodiments of the invention may be practiced, in accordance with one embodiment of the present invention. Device 400 includes integrated circuit 402, computer readable storage medium 404, and external interface 406, in one embodiment.

When all or part of the methods of the various embodiments are implemented in hardware, integrated circuit 402 includes one or more ASICs, each of which include the logic for performing all or part of the one-way hash function (e.g., the front computation logic block 202 and the systolic computation logic block 204, FIG. 2). In such an embodiment, device 400 may also include a processor (not shown), which places the input message block in a format that is useable by the ASIC. For example, a processor may be used to pad the message, divide the message into blocks, and/or initialize various registers. The A, B, C, D registers could be implemented in integrated circuit 402, a processor, computer readable storage medium 404, or another device.

The message and/or message blocks could be stored in a memory device, such as computer readable storage medium 404, or the message and/or message blocks could be received through external interface 406. Computer readable storage medium 404 could be, for example, RAM, ROM, hard drive, CD, magnetic disk, disk drive, a combination of these types of storage media, and/or other types of storage media that are well known to those of skill in the art. When all or part of the methods of the various embodiments are implemented in software, computer readable storage medium 404 also could be used to store computer executable instructions, which carry out all or part of the methods, when executed. In such an embodiment, integrated circuit 402 could be a microprocessor, ASIC or another type of integrated circuit capable of executing the computer executable instructions. In other embodiments, where storage of computer executable instructions, message data, message digests, or other data is not necessary, device 400 may not include storage medium 404.

External interface 406 could be, for example, a user interface (e.g., a keyboard, speaker, or other input device) or an interface to a wired or wireless external network, system or device. External interface 406 could be used to receive input messages and/or message blocks, and/or could be used to transmit or receive message digests, digital signatures, or verification or other data that was generated using an embodiment of the present invention. Data received and/or transmitted by external interface 406 could be sent to or received from, respectively, either or both integrated circuit 402 and/or storage medium 404. In other embodiments, where transmission or receipt of message data, message digests or other data is not necessary, device 400 may not include external interface 406.

Conclusion

Various embodiments of a one-way hash algorithm have been described. The various embodiments can be used to produce a message digest that is identical to a message digest produced by MD5, given the same input message. However, the algorithms of the various embodiments produce the message digest using the equivalent of approximately half the clock cycles and less logic depth than MD5.

In the foregoing detailed description, reference is made to the accompanying drawings, which form a part hereof, and in which are shown by way of illustration specific embodiments in which the invention may be practiced. These embodiments are described in sufficient detail to enable those skilled in the art to practice the invention.

It will be appreciated by those of ordinary skill in the art that any arrangement, which is calculated to achieve the same purpose, may be substituted for the specific embodiment shown. In addition, although certain applications of the embodiments have been listed above, the embodiments could be incorporated into any other application that could benefit from the use of a one-way hash algorithm. The various embodiments could also be used, with or without modifications, as compatible, alternative implementations of other hash algorithms. For example, but not by way of limitation, the embodiments could be used as compatible algorithms to future MD5 implementations. Therefore, all such applications and alternative implementations are intended to fall within the spirit and scope of the present invention.

This application is intended to cover any adaptations or variations of the present invention. The foregoing detailed description is, therefore, not to be taken in a limiting sense, and it will be readily understood by those skilled in the art that various other changes in the details, materials, and arrangements of the parts and steps, which have been described and illustrated in order to explain the nature of this invention, may be made without departing from the spirit and scope of the invention as expressed in the adjoining claims.

What is claimed is:

1. A method for creating a message digest from a message, wherein a sequence of input words is derived from the message, and the method comprises:
performing a portion of an operation, wherein the operation is a set of processes that operates on a word of the sequence;
performing a portion of a next operation in parallel with performing the portion of the operation, wherein the next operation is a set of processes that operates on a next word of the sequence; and
repeating performing the portion of the operation and performing the portion of the next operation until processes have been performed that sequentially operate on all remaining words of the sequence.

2. The method as claimed in claim 1, wherein the operation comprises:
performing a non-linear function on three of four variables stored in three of four registers;
adding an output of the non-linear function to the word, a constant word, and a fourth variable of the four variables, resulting in a first sum;
circularly shifting the first sum by a number of bits, resulting in a shifted result;
adding the shifted result to contents of one of the four registers, resulting in a second sum; and
replacing contents of one of the four registers with the second sum.

3. The method as claimed in claim 2, further comprising:
temporarily storing the second sum, resulting in a stored sum, and
wherein replacing the contents of one of the four registers comprises replacing the contents with the stored sum.

4. The method as claimed in claim 1, wherein performing the portion of the next operation comprises:
performing a non-linear function on three of four variables; and
adding together the next word, a constant word, and a fourth variable of the four variables, resulting in a first sum.

5. The method as claimed in claim 4, further comprising performing remaining processes of the next operation after performing the portion of the next operation.

6. The method as claimed in claim 5, wherein performing the remaining processes comprises:
adding an output of the non-linear function to the first sum, resulting in a second sum;
circularly shifting the second sum by a number of bits, resulting in a shifted result; and
adding the shifted result to one of the four variables.

7. The method as claimed in claim 1, wherein when the operation is a first operation being performed on a first word of the sequence, the method further comprises:
performing a second portion of the operation before performing the portion of the operation.

8. The method as claimed in claim 7, wherein the second portion of the operation comprises:
performing a non-linear function on three of four variables stored in three of four registers; and
adding an output of the non-linear function to the word, a constant word, and a fourth variable of the four variables, resulting in a first sum.

9. The method as claimed in claim 8, wherein the first portion of the operation comprises:
circularly shifting the first sum by a number of bits, resulting in a shifted result;
adding the shifted result to contents of one of the four registers, resulting in a second sum; and
replacing contents of one of the four registers with the second sum.

10. The method as claimed in claim 1, wherein performing the portion of the operation and performing the portion of the next operation are completed during a first clock cycle, and the method further comprises performing remaining processes of the next operation during a next clock cycle.

11. The method as claimed in claim 1, wherein performing the portion of the first operation is completed during a first clock cycle, and when the operation is a first operation being performed on a first word of the sequence, the method further comprises:
performing a second portion of the operation during a preceding clock cycle.

12. The method as claimed in claim 1, wherein the message comprises one or more 512-bit blocks, each of which includes sixteen 32-bit words, and the message digest includes 128 bits.

13. The method as claimed in claim 1, wherein the message digest is identical to another message digest computed by MD5, given a same message.

14. A computer readable medium having computer executable instructions stored thereon for performing a method for creating a message digest from a message, wherein a sequence of input words is derived from the message, and the method comprises:
performing a portion of an operation, wherein the operation is a set of processes that operates on a word of the sequence;
performing a portion of a next operation in parallel with performing the portion of the operation, wherein the next operation is a set of processes that operates on a next word of the sequence; and
repeating performing the portion of the operation and performing the portion of the next operation until processes have been performed that sequentially operate on all remaining words of the sequence.

15. The computer readable medium as claimed in claim 14, wherein the operation comprises:
performing a non-linear function on three of four variables stored in three of four registers;
adding an output of the non-linear function to the word, a constant word, and a fourth variable of the four variables, resulting in a first sum;
circularly shifting the first sum by a number of bits, resulting in a shifted result;
adding the shifted result to contents of one of the four registers, resulting in a second sum; and
replacing contents of one of the four registers with the second sum.

16. The computer readable medium as claimed in claim 14, wherein performing the portion of the next operation comprises:
performing a non-linear function on three of four variables; and
adding together the next word, a constant word, and a fourth variable of the four variables, resulting in a first sum.

17. The computer readable medium as claimed in claim 16, wherein the method further comprises performing remaining processes of the next operation after performing the portion of the next operation.

18. The computer readable medium as claimed in claim 17, wherein performing the remaining processes comprises:
adding an output of the non-linear function to the first sum, resulting in a second sum;
circularly shifting the second sum by a number of bits, resulting in a shifted result; and
adding the shifted result to one of the four variables.

19. The computer readable medium as claimed in claim 14, wherein when the operation is a first operation being performed on a first word of the sequence, the method further comprises:
performing a second portion of the operation before performing the portion of the operation.

20. The computer readable medium as claimed in claim 19, wherein the second portion of the operation comprises:
performing a non-linear function on three of four variables stored in three of four registers; and
adding an output of the non-linear function to the word, a constant word, and a fourth variable of the four variables, resulting in a first sum.

21. The computer readable medium as claimed in claim 20, wherein the first portion of the operation comprises:
circularly shifting the first sum by a number of bits, resulting in a shifted result;
adding the shifted result to contents of one of the four registers, resulting in a second sum; and
replacing contents of one of the four registers with the second sum.

22. The method as claimed in claim 14, wherein performing the portion of the operation and performing the portion of the next operation are completed during a first clock cycle, and the method further comprises performing remaining processes of the next operation during a next clock cycle.

23. The method as claimed in claim 14, wherein performing the portion of the first operation is completed during a first clock cycle, and when the operation is a first operation being performed on a first word of the sequence, the method further comprises:
performing a second portion of the operation during a preceding clock cycle.

24. The computer readable medium as claimed in claim 14, wherein the message comprises one or more 512-bit blocks, each of which includes sixteen 32-bit words, and the message digest includes 128 bits.

25. The computer readable medium as claimed in claim 14, wherein the message digest is identical to another message digest computed by MD5, given a same message.

26. An integrated circuit for creating a message digest from a message, wherein a sequence of input words is derived from the message, and the integrated circuit comprises:
a first logic block which performs a portion of an operation during a clock cycle, wherein the operation is a set of processes that operates on a word of the sequence, performs a portion of a next operation during the clock cycle, wherein the next operation is a set of processes that operates on a next word of the sequence, and repeats performing the portion of the operation and performing the portion of the next operation until processes have been performed that sequentially operate on all remaining words of the sequence,
wherein additional passes through the first logic block are made until calculations have been performed that sequentially operate on all remaining words of the sequence.

27. The integrated circuit as claimed in claim 26, wherein the first logic block comprises:
a non-linear function block, which receives three of four variables; and
one or more first adders, which add together the next word, a constant word, and a fourth variable of the four variables, resulting in a first sum;
a second adder, which adds an output of the non-linear function block to the first sum, resulting in a second sum;
a shifter, coupled to the second adder, which circularly shifts the second sum by a number of bits, resulting in a shifted result; and
a third adder, coupled to the shifter, which adds the shifted result to one of the four variables.

28. The integrated circuit as claimed in claim 27, further comprising:
a multiplexer, coupled to the second adder, which passes the output of the non-linear function and the first sum to the second adder.

29. The integrated circuit as claimed in claim 26, further comprising:
a second logic block, coupled to the first logic block, which performs a second portion of the operation during a preceding clock cycle.

30. The integrated circuit as claimed in claim 29, wherein the second logic block comprises:
a non-linear function block, which receives three of four variables stored in three of four registers; and
one or more first adders, coupled to the non-linear function block, which add an output of the non-linear function block to the word, a constant word, and a fourth variable of the four variables, resulting in a first sum.

31. The integrated circuit as claimed in claim 26, wherein the message comprises one or more 512-bit blocks, each of which includes sixteen 32-bit words, and the message digest includes 128 bits.

32. The integrated circuit as claimed in claim 26, wherein the message digest is identical to another message digest computed by MD5, given a same message.

33. An integrated circuit for creating a message digest from a message, wherein a sequence of input words is derived from the message, and the integrated circuit comprises:
a front computation logic block, which performs a portion of a first operation within a round of multiple operations during one or more clock cycles, wherein the first operation is a set of processes that operates on a word of the sequence; and
a systolic computation logic block, coupled to the front computation logic block, which performs a second portion of the first operation during one or more subsequent clock cycles, and performs a portion of a next operation during the one or more subsequent clock cycles, wherein the next operation is a set of processes that operates on a next word of the sequence, and the systolic computation block iterates until remaining operations within the round of multiple operations are completed.

34. The integrated circuit as claimed in claim 33, wherein the front computation logic block comprises:
a non-linear function block, which receives three of four variables stored in three of four registers; and
one or more first adders, coupled to the non-linear function block, which add an output of the non-linear function block to the word, a constant word, and a fourth variable of the four variables, resulting in a first sum.

35. The integrated circuit as claimed in claim 33, wherein the systolic computation logic block comprises:
a non-linear function block, which receives three of four variables; and
one or more first adders, which add together the next word, a constant word, and a fourth variable of the four variables, resulting in a first sum;
a second adder, which adds an output of the non-linear function block to the first sum, resulting in a second sum;
a shifter, coupled to the second adder, which circularly shifts the second sum by a number of bits, resulting in a shifted result; and
a third adder, coupled to the shifter, which adds the shifted result to one of the four variables.

36. The integrated circuit as claimed in claim 33, wherein the message digest is identical to another message digest computed by MD5, given a same message.

37. An electronic device comprising:
an integrated circuit, which creates a message digest from a message, wherein a sequence of input words is derived from the message, and the message digest is created by performing a portion of an operation, wherein the operation is a set of processes that operates on a word of the sequence, performing a portion of a next operation in parallel with performing the portion of the operation, wherein the next operation is a set of processes that operates on a next word of the sequence, and repeating performing the portion of the operation and performing the portion of the next operation until processes have been performed that sequentially operate on all remaining words of the sequence.

38. The electronic device as claimed in claim 37, wherein the integrated circuit is a processor, and the electronic device further comprises:
a computer readable medium, coupled to the integrated circuit, which has computer executable instructions stored thereon that cause the processor to perform the portion of the operation, perform the portion of the next operation, and repeat performing.

39. The electronic device as claimed in claim 37, wherein the integrated circuit comprises:
a first logic block, which performs the portion of the operation during a clock cycle, performs the portion of the next operation during the clock cycle, and repeats performing the portion of the operation and performing the portion of the next operation until processes have been performed that sequentially operate on all remaining words of the sequence.

40. The electronic device as claimed in claim 39, wherein the integrated circuit further comprises:
a second logic block, coupled to the first logic block, which performs a second portion of the operation during a preceding clock cycle.

41. The electronic device as claimed in claim 37, further comprising:
an external interface, which transmits the message digest.

42. The electronic device as claimed in claim 37, further comprising:
an external interface, which transmits data that was generated from the message digest.
